(19) United States
(12) Patent Application Publication
(10) Pub. No.: US 2003/0120791 A1
(43) Pub. Date: Jun. 26, 2003

(54) Multi-thread, multi-speed, multi-mode interconnect protocol controller

(76) Inventors: David M. Weber, Monument, CO (US); Silvia E. Jaeckel, Colorado Springs, CO (US); Mark Miquelon, Colorado Springs, CO (US)

Correspondence Address: PETER SCOTT, INTELLECTUAL PROPERTY LAW DEPARTMENT, LSI LOGIC CORPORATION, M/S D-106, 1551 McCARTHY BLVD., MILPITAS, CA, 95035, US

(21) Appl. No.: 10/027,743

(22) Filed: Dec. 20, 2001

(51) Int. Cl. G06F 15/16

(52) U.S. Cl. 709/231

(57) ABSTRACT

The present invention is a novel system and method for implementing multiple protocol definitions including multiple interconnect protocols and protocol methods. Protocol methods may include a single-thread, multi-speed interconnect protocol method and a multi-thread, single-speed interconnect protocol method with shared resources on a single die. Various aspects of serializer/deserializer, encoder/decoder, aggregator, and protocol functions may be shared among both protocol definitions to provide cost and real estate efficiency.

### FIELD OF THE INVENTION

The present invention relates generally to communication controllers and more specifically to multiple protocol definition controller chips.

### BACKGROUND OF THE INVENTION

Existing interconnect protocols for communication applications are continually expanded to increase data transfer rates. In the past, data transfer rates were increased by increasing speed on a single thread. A current development in increasing data transfer rates involves dividing data over multiple threads and transmitting it in parallel at a given speed. Data transmitted in parallel is received in parallel over multiple threads at a given speed and assembled.

The implementation of a separate protocol methods such as a single-thread, multi-speed (STMS) circuit and a separate multi-thread, single-speed (MTSS) circuit is costly. High costs result due to the multiplicity of components and from the cost of a protocol controller that increases with the size and number of its integrated circuit components. Consequently, a method and system that implements both an STMS and MTSS technology with shared resources on a single die in order to reduce the cost of such a communication protocol controller is necessary.

### SUMMARY OF THE INVENTION

Accordingly, the present invention is directed, in one embodiment, to a novel system and method for implementing an STMS-MTSS-dual-mode interconnect protocol method with shared resources on a single die. In one embodiment of the invention, an STMS-MTSS-dual-mode interconnect protocol definition may be implemented with Fibre Channel interconnect protocol. Fibre Channel protocol methods for STMS (1 Gigabit, 2 Gigabit, and 4 Gigabit) and MTSS (10 Gigabit) operations exist. Thus, in one embodiment of the invention, a 1 Gigabit, 2 Gigabit, and 4 Gigabit Fibre Channel protocol definition may be implemented with a 10 Gigabit Fibre Channel definition with shared resources on a single die.

In an embodiment of the invention, a controller of the present invention may include real estate efficient circuitry that may be shared among multiple protocol methods. For example, a controller of the present invention may include serializer/deserializer circuits, encoding circuits and decoding circuits, data aggregators, data presenters, and protocol processors that may be utilized to support multiple protocol methods. One example of a controller of the present invention is a controller capable of being placed on a single die that may implement a 10 Gb Fibre Channel protocol definition and a multi-speed Fibre Channel protocol definition.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous objects and advantages of the present invention may be better understood by those skilled in the art by reference to the accompanying figures in which:

FIG. 1 depicts an embodiment of a controller of the present invention;

FIG. 2 depicts an embodiment of a process for converting at least one serial differential bit stream to an internal parallel word in accordance with the present invention;

FIG. 3 depicts an embodiment of a process for converting an internal parallel word to at least one serial differential bit stream in accordance with the present invention; and

FIG. 4 depicts an embodiment of a controller for implementing a multiple protocol definitions in accordance with the present invention.

### DETAILED DESCRIPTION OF THE INVENTION

Reference will now be made in detail to an embodiment of the invention, examples of which are illustrated in the accompanying drawings.

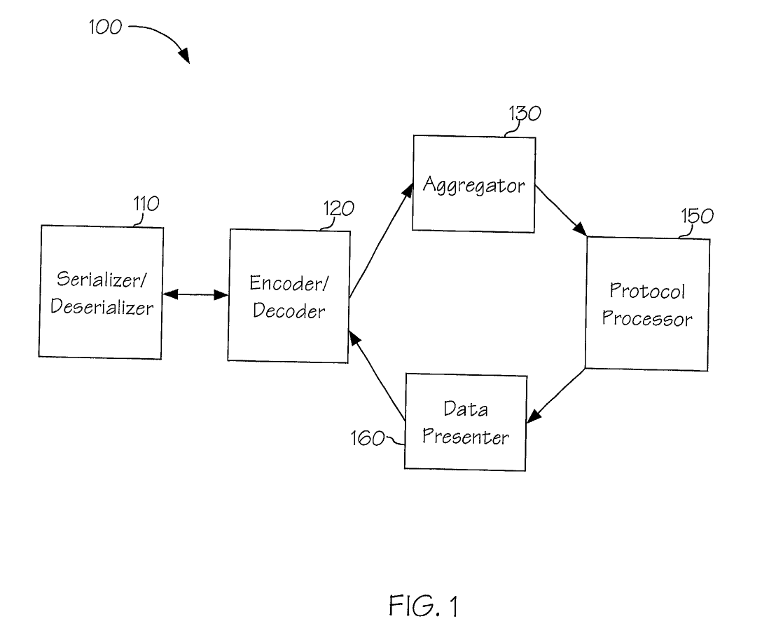

Referring to FIG. 1, an embodiment of a controller 100 of the present invention is shown. In one embodiment of the invention, controller 100 may be placed upon a single die and may implement multiple interconnect protocol definitions utilizing shared resources. An interconnect protocol definition may include a specific interconnect protocol and a specific interconnect protocol method. For example, an interconnect protocol may include Fibre Channel or Ethernet where interconnect protocol methods may include an STMS interconnect protocol method, a MTSS interconnect protocol method, and a multiple-thread, multiple-speed (MTMS) protocol method. The ability to transmit and receive data in various fashions according to multiple protocol definitions is advantageous as multiple protocol definitions may be supported in a cost efficient and real estate efficient manner.

Controller 100 may convert an internal parallel word into at least one serial differential bit stream on a transmission function and may convert at least one serial differential bit stream to an internal parallel word on a reception function. In one embodiment of the invention, controller 100 transmits and receives data according to a 10 Gigabit Fibre Channel protocol definition and a multi-speed Fibre Channel protocol definition. A multi-speed Fibre Channel protocol definition may allow the transfer of data at a rate of 1 Gigabits per second, 2 Gigabits per second and 4 Gigabits per second.

In an embodiment of the invention, controller 100 may include a serializer/deserializer 110, an encoder/decoder 120, an aggregator 130, a protocol processor 150, and a data presenter 160. Serializer/deserializer 110 may convert lower-speed parallel data to and from higher-speed serial data. Encoder/decoder 120 may encode and decode data according to multiple protocol definitions. For example, in one embodiment of the invention, the encoding function of encoder/decoder 120 converts 8-bit data to 10-bit data according to the 8B/10B Fibre Channel coding scheme. The decoding function of encoder/decoder 120 may convert 10-bit data to 8-bit data via the 8B/10B Fibre Channel coding scheme.

An aggregator 130 may properly align data according to multiple protocol definitions. For example, in one embodiment aggregator 130 assembles consecutive bytes into a single aligned data word from a single byte stream as required for a 4 Gb, 2 Gb, 1 Gb Fibre Channel protocol definition. An aggregator 130 may include an elasticity function to provide speed matching between the clock rate of the incoming data and the clock rate of protocol processor 150. Protocol processor 150 processes a resulting word for analysis. In one embodiment of the invention, protocol processor 150 implements each protocol definition. In an alternative embodiment, a separate protocol processor and a separate aggregator may be utilized for implementing each protocol definition.

On a transmission function, data presenter 160 takes a data word selected from protocol processor 150 and presents the data for encoding according to the proper protocol definition. Data presenter 160 is capable of performing an algorithm on a word to present data according to a desired protocol definition. For example, a desired protocol such as Fibre Channel may prescribe a method of presenting data for encoding. It should be understood by those with ordinary skill in the art that elements of controller 100 describe functional aspects of controller 100 and may not refer to a specific component. Further, each element of controller 100 may represent a set of instructions executed to perform a desired task in one embodiment of the invention.

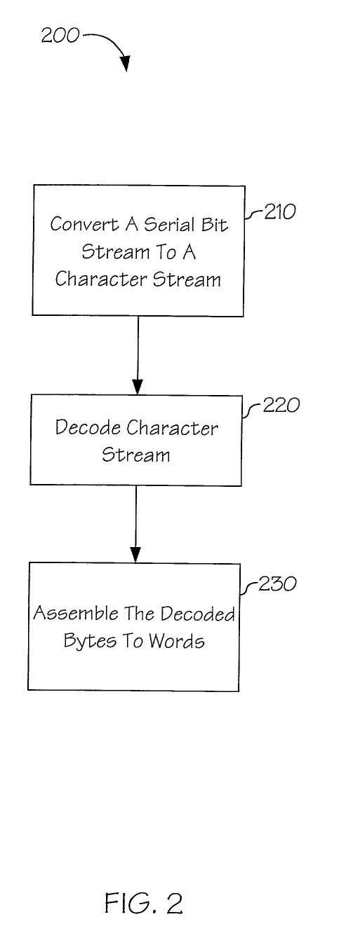

Referring now to FIG. 2, an embodiment of a process 200 for converting at least one serial differential bit stream to an internal parallel word in accordance with the present invention is shown. In one embodiment of the invention, process 200 is performed by controller 100 of FIG. 1. Process 200 may begin by the conversion of at least one serial differential bit stream to a parallel bit stream, i.e. a character stream 210. In an STMS protocol method each serial differential bit stream is converted to a character stream separately on each thread. In a MTSS protocol method, multiple serial differential bit streams on different threads are converted to a single character stream. Resources accomplishing the deserialization function may be shared by both methods.

Consecutive characters as presented by a character stream are decoded 220. Decoding may be accomplished according to the desired protocol. In one embodiment of the invention, decoding may be accomplished according to the Fibre Channel 8B/10B coding scheme. The decoding function may be similar for both STMS and MTSS protocol methods which may allow circuitry to be utilized between both protocol methods. The decoded bytes may be assembled into words according to the desired protocol definition 230. For example, a multi-speed Fibre Channel protocol definition assembles four consecutive bytes in a single byte stream into a single aligned word stream. A 10 Gb Fibre Channel protocol definition requires the assembly of four byte streams to provide a single aligned word stream. Upon formulation of a word, the word may be transferred to a protocol processor for analysis.

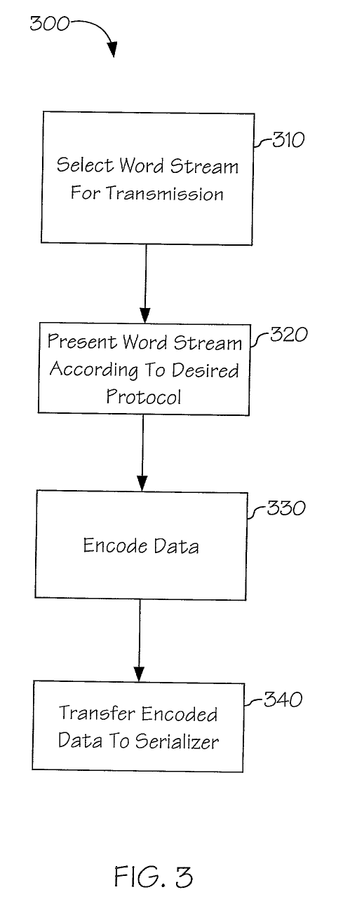

Referring to FIG. 3, an embodiment of a process 300 for converting an internal parallel word to at least one serial differential bit stream in accordance with the present invention is shown. In one embodiment of the invention, process 300 is performed by controller 100 of FIG. 1. Process 300 is representative of a transmission function performed by controller 100 of FIG. 1. Process 300 may begin by the selection of a word stream for transmission 310. Word stream may be maintained at a protocol processor. The word stream may be presented to an encoder according to the desired protocol definition. In one embodiment, an algorithm is performed on the word stream. The algorithm utilized is in conformity with the desired protocol definition. For example, an STMS protocol method presents a word in a single thread to an encoding function. A MTSS protocol method divides a word into multiple entities and presents each entity to an encoding function in a thread.

The presented data stream is then encoded 330. Encoding of the data stream may be accomplished according to the desired protocol definition. For example, data may be encoded according to the Fibre Channel 8B/10B coding scheme. The encoding function may be similar for various protocol definitions, which may allow circuitry to be shared between protocol definitions. The encoded character stream is transferred to a serializer 340. A serializer converts a lower-speed character stream from the encoder to a higher-speed serial differential bit stream.

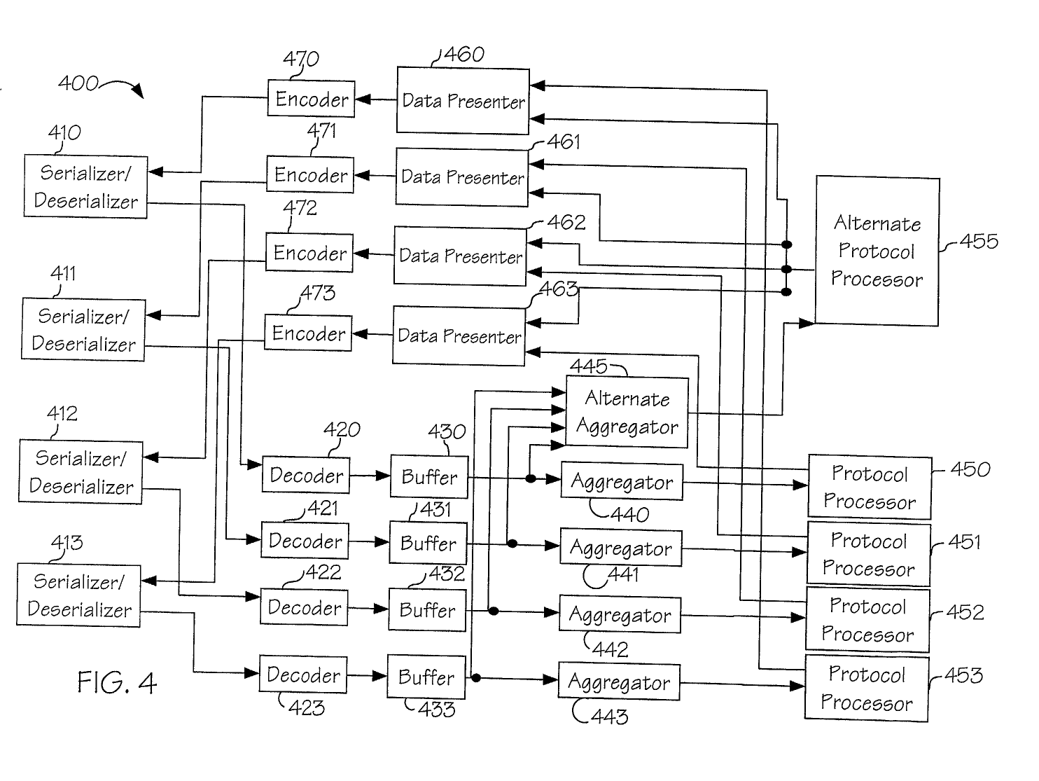

Referring to FIG. 4, an embodiment of a controller 400 for implementing multiple protocol definitions in accordance with the present invention is shown. In one embodiment of the invention, controller 400 performs a reception and transmission function, and is capable of performing the process 200 and 300 as described in FIGS. 2 and 3. An advantageous aspect of the controller 400 of the present invention is the ability to be placed upon a single die. Further, controller 400 may share the resources of a single set of serializer/deserializer circuits, encoders, decoders, aggregators, data presenters, and protocol processors in the implementation of multiple protocol definitions, such as an STMS and MTSS interconnect protocol method. For example, serializer/deserializer circuits 410413 provide four lanes in accordance with a single-channel 10 Gb Fibre Channel protocol definition and may provide the ability to implement one to four channels of a multi-speed Fibre Channel protocol definition.

In a reception function, a deserializer portion of serializer/deserializer circuits 410-413 may convert higher-speed serial data to lower-speed parallel data. The parallel data is decoded by decoders 420-423 and delivered to buffers 430433. Buffer 430-433 may include a register bank in which the decoded data is stored in a first-in-first-out (FIFO) fashion. Aggregators 440-443 receive data stored in buffers 430-433 and align the data properly according to a desired protocol definition. Aggregators 440-443 may align the data according to STMS protocol method in one embodiment of the invention. Alternate aggregator 445 may also be coupled to buffers 430-433 and may align data according to MTSS protocol method. Further, aggregators 440-443 and alternate aggregator 445 are capable of providing an elasticity function to provide speed matching between the clock rate of the data and the clock rate of protocol processors 450-453 and 455 respectively. A MTSS protocol method utilizes a deserializer portion of all serializer/deserializer 410-413 to implement one reception function, for which each deserializer receives an entity of data on each thread. In an STMS protocol method, a single deserializer may be utilized to implement a reception function. However, in alternative embodiments of the invention, multiple reception functions may be implemented for the STMS protocol method. In addition to the use of multiple deserializers for operation of multiple reception functions for an STMS protocol method, multiple entities of decoder, aggregator with elasticity function, and protocol processor may be necessary.

Protocol processors 450-453 may process the data according to the STMS protocol method. Alternate protocol processor 455 may process data according to the MTSS protocol method. In a transmission function, protocol processor 450453 and alternate protocol processor 455 may maintain a parallel word that is sent to data presenter 460-463. Data presenter 460-463 may perform an algorithm on the data to present data according to a desired protocol definition. The algorithm may be highly specific to the desired protocol such as Ethernet or Fibre Channel. Data presenter 460-463 may include an input selector which determines the protocol definition in which data presenter 460-463 will align the data. Input selector may be a signal driven by a pin in which a desired protocol definition is selected. This may be advantageous for an application in which only one protocol definition will be utilized. Input selector may also include a signal driven by a register bit. This may be advantageous for an application in which multiple protocol definitions may be utilized.

After the data has been modified according to the desired protocol definition, the data stream is transferred to encoders 470-473 for encoding. Encoding may be accomplished according to the desired protocol definition. One method may be according to the Fibre Channel 8B/10B coding scheme. A MTSS protocol method utilizes a serializer portion of all serializer/deserializer 410-413 to implement one transmission function, for which each serializer transmits an entity of data on each thread. In an STMS protocol method, a single serializer may be utilized to implement a transmission function. However, in alternative embodiments of the invention, multiple transmission functions may be implemented for the STMS protocol method. In addition to the use of multiple serializers for operation of multiple transmission functions for an STMS protocol method, multiple entities of an encoder, a protocol processor, and data presenter may be necessary.

In an alternative embodiment of the invention, alternate protocol processor 455 is combined with one or more protocol processors 450-453. This may allow reuse of existing circuitry and may reduce a die size requirement. Further, in another embodiment of the invention, multiple implementations of a STMS protocol method may be realized. For example, one, two, or three channels may be realized by one of ordinary skill in the art for the implementation of a 4 Gb, 2 Gb, 1 Gb multi-speed Fibre Channel protocol definition.

In yet another alternative embodiment, the order in which data is aligned may be altered without departing from the scope and spirit of the present invention. For example, aggregation of the bytes may occur before performing a decode operation. Also, it may be possible to perform a partial aggregation, decode the data, and then perform a final aggregation. Similarly, the steps performed by controller 400 may be altered regarding the transmission function of the controller 400. It should be understood by those with ordinary skill in the art that elements of controller 100 describe functional aspects of controller 100 and may not refer to a specific component. Further, each element of controller 100 may represent a set of instructions executed to perform a desired task in one embodiment of the invention.

While embodiments of implementing an STMS-MTSS-dual-mode interconnect protocol definition include examples of multiple Fibre Channel protocol definitions, it should be understood by one of ordinary skill in the art that other types of interconnect protocols and interconnect protocol methods may be utilized in accordance with the present invention without departing from the scope and spirit of the present invention. For example, interconnect protocols may include Fibre Channel, Ethernet and other interconnect protocols. Further, interconnect protocol methods may include STMS, MTSS, and a multiple-thread, multiple-speed (MTMS) protocol method, without departing from the scope and spirit of the present invention.

Further, it is believed that the present invention and many of its attendant advantages will be understood by the foregoing description, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. An apparatus, comprising:
(a) a single die;
(b) a first circuitry disposed on said single die including:
a deserializer for converting at least one serial differential bit stream into a character stream;
a decoder receiving said character stream to form a decoded data stream; and
a means for aggregating said decoded data stream and reconstructing a parallel word according to a desired protocol definition;
(c) a second circuitry disposed on said single die including:
a means for presenting a second parallel word according to said desired protocol definition to form an altered data stream,
an encoder receiving said altered data stream to form an encoded data stream;
a serializer for converting said encoded data stream into said at least one serial differential bit stream, wherein said first circuitry and said second circuitry are capable of implementing at least two interconnect protocol definitions.

2. The apparatus as claimed in claim 1, wherein said at least two interconnect protocol definitions include a single-thread, multiple-speed protocol method, a multiple-thread, single-speed protocol method, and a multiple-thread, multiple-speed protocol method.

3. The apparatus as claimed in claim 2, wherein at least two interconnect protocol definitions include a 10 Gigabit Fibre Channel protocol definition and a 4 Gigabit, 2 Gigabit, 1 Gigabit Fibre Channel protocol definition.

4. A method, comprising:
(a) converting a at least one serial data stream to a character stream;
(b) decoding of said character stream to form a decoded data stream; and
(c) aggregating said decoded data stream according to a desired interconnect protocol definition;
wherein circuitry disposed on a single die is capable of transforming at least one serial bit stream into a word in accordance with at least two interconnect protocol definitions.

5. The method as claimed in claim 4, wherein said at least two interconnect protocol definitions include a single-thread, multiple-speed protocol method, a multiple-thread, single-speed protocol method and a multiple-thread, multiple-speed protocol method.

6. The method as claimed in claim 5, wherein said at least two interconnect protocol definitions include a 10 Gigabit Fibre Channel protocol definition and a 4 Gigabit, 2 Gigabit, 1 Gigabit Fibre Channel protocol definition.

7. The method as claimed in claim 6, wherein decoding of said at least one serial data streams converts 10 bits of data to 8 bits of data.

8. The method as claimed in claim 6, wherein aggregating of said decoded data stream aligns said decoded data stream to reconstruct said parallel data word according to said desired interconnect protocol definition.

9. A method, comprising:
(a) selecting a word stream for transmission;
(b) presenting said word stream according to a desired interconnect protocol definition to form an altered data stream;
(c) encoding said altered data stream to form an encoded data stream; and
(d) converting said encoded data stream to at least one serial differential bit stream; wherein circuitry disposed on a single die is capable of transforming said word stream into at least one serial differential bit stream in accordance with at least two interconnect protocol definitions.

10. The method as claimed in claim 9, wherein said at least two interconnect protocol definitions include a single-thread, multiple-speed protocol method, a multiple-thread, single-speed protocol method, and a multiple-thread, multiple-speed protocol method.

11. The method as claimed in claim 10, wherein said at least two interconnect protocol definitions are a 10 Gigabit Fibre Channel protocol definition and a 4 Gigabit, 2 Gigabit, 1 Gigabit Fibre Channel protocol definition.

12. The method as claimed in claim 11, wherein encoding of said altered data stream converts 8 bits of data to 10 bits of data.

13. An apparatus, comprising:
(a) a single die;
(b) means for transforming at least one serial differential bit stream into a parallel word; said transforming means being disposed on said single die;
(c) means for converting a second parallel word into at least one serial differential bit stream; said converting means being disposed on said single die; said converting means including an input selector in which said apparatus operates according to a selected protocol definition; wherein said transforming means and said converting means are capable of implementing at least two interconnect protocol definitions.

14. The apparatus as claimed in claim 13, wherein said at least two interconnect protocol definitions include a single-thread, multiple-speed protocol method, a multiple-thread, single-speed protocol method and a multiple-thread, multiple-speed protocol method.

15. The apparatus as claimed in claim 14, wherein at least two interconnect protocol definitions include a 10 Gigabit Fibre Channel protocol definition and a 4 Gigabit, 2 Gigabit, 1 Gigabit Fibre Channel protocol definition.

16. The apparatus as claimed in claim 13, wherein said transforming means includes a deserializer, a decoder, and an aggregator capable of implementing at least two interconnect protocol definitions.

17. The apparatus as claimed in claim 13, wherein said converting means includes a data presenter, an encoder, and a serializer capable of implementing at least two interconnect protocol definitions.
